(19) United States
(12) Patent Application Publication
(10) Pub. No.: US 2024/0080100 A1
(43) Pub. Date: Mar. 7, 2024

(54) BROADBAND RADIO FRQUENCY SIGNAL OPTICAL FIBER PHASE-STABLE TRANSMISSION SYSTEM

(71) Applicant: Zhejiang University, Hangzhou (CN)

(72) Inventors: Xiaofeng Jin, Hangzhou (CN); Yaoqi Xu, Hangzhou (CN); Jichen Qiu, Hangzhou (CN); Xiaohuan Sun, Hangzhou (CN); Xianbin Yu, Hangzhou (CN); Xiangdong Jin, Hangzhou (CN); Yinfang Xie, Hangzhou (CN)

(21) Appl. No.: 17/929,532

(22) Filed: Sep. 2, 2022

(51) Int. Cl. H04B 10/2575; H04B 10/2507; H04B 10/548; H04J 14/02

(52) U.S. Cl. CPC H04B 10/2575; H04B 10/2507; H04B 10/548; H04J 14/02

(57) ABSTRACT

A broadband radio frequency signal optical fiber phase-stable transmission system includes a local end and a remote end connected by a dispersion compensation module and an optical fiber. The local end modulates a first auxiliary signal whose frequency is half of the frequency of the to-be-transmitted signal and a second auxiliary signal whose frequency is 1.5 times the frequency of the to-be-transmitted signal through the optical carrier and filters out a lower sideband to obtain an optical signal containing only the optical carrier, a first signal, and a second signal corresponds to the optical signal of the first-order upper sideband. The optical signal is transmitted to the remote end through the dispersion compensation module and the optical fiber.

### FIELD OF THE DISCLOSURE

This disclosure belongs to the technical field of microwave photonics, and in particular relates to a broadband radio frequency signal optical fiber phase-stable transmission system.

### BACKGROUND OF THE DISCLOSURE

The transmission methods of radio frequency signals include wired transmission based on cables, overhead open wires and optical fibers, and wireless transmission. The wired transmission methods such as cable-based are bulky, expensive, and have serious transmission attenuation, which is not conducive to long-distance transmission of signals. The wireless transmission methods are highly susceptible to external electromagnetic and environmental interference. Optical fiber has the characteristics of low loss, light weight and strong anti-electromagnetic interference ability. Using optical fiber to transmit RF signals has the advantages of long distance, high stability and low loss that other transmission methods cannot achieve. However, due to the characteristics of the optical fiber itself, it is easily interfered by external environmental factors (such as temperature changes and mechanical vibrations, etc.), resulting in changes in its refractive index and effective length, and causing changes in the transmission delay in the optical fiber link, which in turn causes the the transmitted signal phase jittered. Therefore, it is necessary to study the optical fiber phase-stable transmission technology of RF signals.

The optical fiber phase-stable transmission technology in the prior art can be mainly divided into the following three categories: (1) optical compensation method: this method stabilizes the phase of the RF signal by directly compensating for the delay of the optical fiber link, so its phase compensation is independent of the frequency of the to-be-transmitted signal, but its response rate is slow and the link adjustable range is limited; (2) electric compensation method: this method mainly realizes stable phase transmission by stabilizing the frequency and phase of the to-be-transmitted signal, and has a fast response speed and an infinite compensation range; however the system for electric compensation method are narrow band, and the circuit for transmitting high-frequency first signals complicated; (3) mixing elimination method: this method cancels the delay jitter introduced by the external by mixing two signals with the same transmission delay; or, pre-basing the phase of the to-be-transmitted signal by mixing the signal with transmission delay with the to-be-transmitted signal, and the phase of the pre-biased signal after transmission through the optical fiber is stabilized by rationally designing the system. In theory, it has an infinite adjustment range, does not require complex phase detection circuits and corresponding compensation circuits, and has a certain rapid compensation capability for the sudden delay jitter in the link, but the system has higher requirements on electronic devices.

### SUMMARY OF THE DISCLOSURE

In order to overcome the deficiencies of the prior art, the present disclosure provides an optical fiber transmission phase-stable system of radio frequency signals with limited bandwidth. Based on the principle of frequency mixing cancellation, the system realizes the optical fiber phase-stable transmission of the radio frequency signal with limited bandwidth.

A broadband radio frequency signal optical fiber phase-stable transmission system includes a local end and a remote end connected by a dispersion compensation module and an optical fiber.

The local end modulates a first auxiliary signal whose frequency is half of the frequency of the to-be-transmitted signal and a second auxiliary signal whose frequency is 1.5 times the frequency of the to-be-transmitted signal through the optical carrier and filters out a lower sideband to obtain an optical signal containing only the optical carrier, a first signal, and a second signal corresponds to the optical signal of the first-order upper sideband. The optical signal is transmitted to the remote end through the dispersion compensation module and the optical fiber.

The remote end demodulates the corresponding first signal and second signal, modulates the first signal by an optical carrier of another wavelength, and then transmits the modulated first signal to the local end and then returns to the remote end, that is, realizes three transmissions of the first signal in the system. At last, the first signal and the second signal are mixed to obtain a stable to-be-transmitted signal.

Further, the local end includes a first electro-optical modulation module, an optical filter, an optical isolator, a first wavelength division multiplexer, and a Faraday rotating mirror. The first electro-optical modulation module modulates the first signal whose frequency is half of the frequency of the to-be-transmitted signal, and the second signal whose frequency is 1.5 times the frequency of the to-be-transmitted signal by the optical carrier to obtain a double-sideband signal containing optical carrier, the first signal and the second signal corresponding to the first-order upper and lower sidebands. The lower sideband is filtered out by the optical filter, and then it is transmitted from the optical fiber module to the remote end through the optical isolator and the first wavelength division multiplexer in turn.

The first wavelength division multiplexer couples two wavelength signals into the same optical fiber link. The Faraday mirror reflects the first signal modulated by another wavelength and transmitted from the remote end to the local end back to the remote end again.

Further, the remote end includes first to third electrical filters, first to third electrical amplifiers, first photodetectors, second photodetectors, second electro-optic modulation modules, and second wavelength division multiplexers, an electrical splitter, an optical circulator, and a mixer. The first photodetector demodulates the optical signal from the local end to obtain the corresponding first signal and second signal, and the first signal is sent to the input end a of the mixer; the second signal is modulated by an optical carrier of another wavelength in the second electro-optic modulation module, and then transmitted to the local end by the optical fiber module through the second wavelength division multiplexer, and reflected back to the remote end by the Faraday rotating mirror at the local end, then demodulated by the second photodetector, sent to the input end b of the mixer, and mixed with the first signal.

The first to third electrical filters are band-pass filters, which are used to filter out the required signals. The first to third electrical amplifiers are used to amplify the signals filtered out by the electrical filters, thereby compensating for the signal transmission process. The second wavelength division multiplexer is used to separate the optical signals of two different wavelengths coupled into the same optical fiber link. The electrical splitter is used to divide the signal demodulated by the first photodetector into two paths, one is the second signal filtered from the first electric filter and transmitted to the mixer, the other is the first signal filtered from the second electric filter and transmitted to the second electro-optic modulation module single-sideband modulation through the optical carrier of another wavelength. The optical circulator is used to change the transmission direction of the signal to realize back-forth transmission.

Further, the dispersion compensation module is a section of dispersion compensation fiber, which is used to compensate the delay effect on the signal due to different wavelengths of the optical carrier or drift and jitter of the carrier.

Further, the first electro-optic modulation module includes a first signal source, a second signal source, a first laser, and a first electro-optic modulator.

The first signal source is used to generate a first signal whose frequency is half the frequency of the to-be-transmitted signal. The first signal can be a narrowband signal or a broadband signal with limited bandwidth. The second signal source is used to generate a frequency that is 1.5 times the frequency of the to-be-transmitted signal. The second first signals used as a local oscillator signal. The first laser is used to provide an optical signal with a wavelength of λ₁; the first electro-optical modulator is a dual-parallel Mach-Zehnder modulator. The optical input port of the first electro-optical modulator is connected to the output port of the first laser. Two radio frequency input ports of the first electro-optical modulator are connected to the output ports of the first signal source and the second signal source, respectively.

Further, the second electro-optical modulation module includes a second laser, an electrical splitter, an electrical phase shifter, and a second electro-optical modulator.

The second laser is used to provide an optical signal with a wavelength of λ₂. The electrical splitter is configured to split the first signal modulated by the first electro-optical modulator into two paths, one of which is transmitted to the radio frequency input port of the second electro-optical modulator, the other to the electrical phase shifter. The electrical phase shifter is used to electrically phase shift the first signal modulated by the first electro-optical modulator. The second electro-optical modulator is a dual-electrode Mach-Zehnder modulator. The optical input port of the second electro-optical modulator is connected to the optical output port of the second laser, and two RF input ports of the second electro-optical modulator are connected with the demodulated first signal and the phase-shifted first signal, respectively, to realize single-sideband modulation.

Further, the phase stabilization method of the optical fiber phase stabilization transmission system is based on the principle of frequency mixing and elimination, by mixing the first auxiliary signal which is transmitted once in the system and whose frequency is half of the frequency of the to-be-transmitted first signal in the system and the second auxiliary signal (second signal being used as the local oscillator signal) with a frequency of 1.5 times the to-be-transmitted signal and transmitted three times in the system to directly offset the delay jitter introduced by the outside, so as to obtain a stable to-be-transmitted signal. In condition that the frequency of the to-be-transmitted signal is 2ω, the greater the transmission bandwidth of the first auxiliary signal, the worse the compensation and suppression ratio of the system's delay and jitter. When the compensation and suppression ratio is a, the maximum bandwidth of the system can transmit signals is

$$\vert Δω \vert = \frac{a}{3 + a} \cdot 2 ω .$$

Based on the above technical solutions, the present disclosure has the following beneficial technical effects:
(1) The present disclosure realizes phase-stable transmission of radio frequency signals based on the principle of frequency mixing and elimination. The system does not need complex real-time phase detection modules and related phase compensation devices, and uses a single frequency mixing at the remote end to achieve signal phase stabilization, reducing the number of mixed signals. The use of frequency converter, the system structure is simpler and the compensation response is faster.
(2) The present disclosure adopts wavelength division multiplexing technology to couple optical signals of different wavelengths into an optical fiber for transmission, which is more practical. The devices in the system are all commercially available, which are easy to implement.
(3) The present disclosure adopts dual-parallel Mach-Zander modulators, which can not only transmit point-frequency signals of different frequency bands, but also realize the transmission of broadband signals.

### BRIEF DESCRIPTION OF DRAWINGS

FIG. 1 is a schematical diagram of a broadband radio frequency signal optical fiber phase-stable transmission system according to the present disclosure.

FIG. 2A and FIG. 2B are schematic diagrams of two electro-optic modulation modules according to the present disclosure. Where, FIG. 2A is a schematic diagram of the first electro-optical modulation module; FIG. 2B is a schematic diagram of a second electro-optical modulation module.

In the drawings: 101—dispersion compensation module; 102—optical fiber; 103—first electro-optical modulation module; 104—optical filter; 105—optical isolator; 106—first wavelength division multiplexer; 107—Faraday rotating mirror; 108-110—first-third electrical filter; 111-113—first-third electrical amplifier; 114—first photodetector; 115—second photodetector; 116—second electro-optic modulation module; 117—second wavelength division multiplexer; 118—electrical splitter; 119—optical circulator; 120—mixer; τ₁˜τ₆—Fixed delay of optical link, where, τ₁ is the fixed delay of the optical fiber link composed of dispersion compensation module 101 and optical fiber 102; τ₂ is the fixed delay of the optical link from port b of the second wavelength division multiplexer 117 to the first photodetector 114; τ₃ is the fixed delay of the optical link from the output port of the second electro-optical modulation module 116 to port a of the optical circulator 119; τ₄ is the fixed delay of the optical link from the port b of the optical circulator 119 to the port c of the second wavelength division multiplexer 117; τ₅ is the fixed delay of the optical link from port c of the second wavelength division multiplexer 117 to Faraday rotating mirror 107; τ₆ is the fixed delay from the port c of the optical circulator to the second electro-optical modulator.

201—first signal source; 202—second signal source; 203—first laser; 204—first electro-optical modulator; 205—second laser; 206—electrical splitter; 207—electrical phase shifter; 208—second electro-optical modulator.

### DETAILED DESCRIPTION OF THE DISCLOSURE

In order to describe the present disclosure more specifically, the technical solutions of the present disclosure are described in detail below in conjunction with the accompanying drawings:

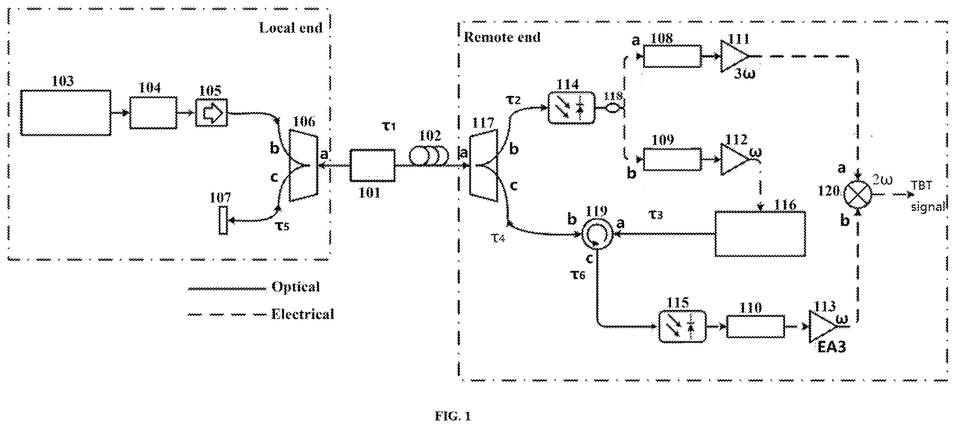

As shown in FIG. 1, it is a schematic diagram of a broadband radio frequency signal optical fiber phase-stable transmission system of the present disclosure, including a local end and a remote end connected by a dispersion compensation module 101 and an optical fiber 102.

The local end includes a first electro-optical modulation module 103, an optical filter 104, an optical isolator 105, a first wavelength division multiplexer 106, and a Faraday rotating mirror 107.

The remote end includes first to third electrical filters 108-110, first to third electrical amplifiers 111-113, a first photodetector 114, a second photodetector 115, a second electro-optic modulation module 116, a second wavelength division multiplexer 117, an electrical splitter 118, an optical circulator 119, and mixer 120.

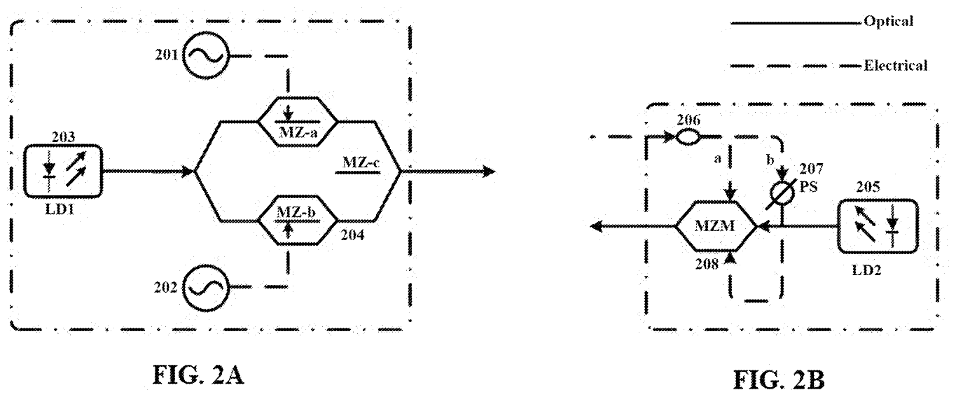

As shown in FIG. 2A and FIG. 2B, two electro-optical modulation modules according to the present disclosure are illustrated. FIG. 2A is a schematic diagram of the first electro-optical modulation module, including a first signal source 201, a second signal source 202, a first laser 203, and a first electro-optical modulator 204. FIG. 2B is a schematic diagram of the second electro-optical modulation module, including a second laser 205, an electrical splitter 206, an electrical phase shifter 207, and a second electro-optical modulator 208. The first electro-optical modulator is a dual-parallel Mach-Zehnder modulator, and the second electro-optical modulator is a dual-electrode Mach-Zehnder modulator.

Assuming that the frequency of the to-be-transmitted first signal in the system is 2ω, when the above-mentioned system transmits a narrowband signal, the first signal source 201 generates a first signal V₁(t)=cos(ωt) whose frequency is half of the frequency of the to-be-transmitted signal, and the second signal source 202 generates a second signal V₂(t)=cos(3ωt) whose frequency is 1.5 times the frequency of the to-be-transmitted signal. The first laser 203 generates an optical carrier with a wavelength λ₁ and the optical carrier is input to the first electro-optical modulator 204 for modulating the radio frequency signal. The first electro-optical modulator 204 is a dual-parallel Mach-Zehnder modulator, and the generated double-sideband optical signal is filtered by the optical filter 104 to generate an optical signal containing only the optical carrier, first signal and second signal corresponding to the first-order upper sideband. The optical first signals connected to the port b of the first wavelength division multiplexer 106 through the optical isolator 105, and passes through the dispersion compensation module 101 and optical fiber 102 at time t₁ to connects to the port b of the first wave division multiplexer 117, that is, transmitted to the remote end.

At the remote end, the optical signal is output through port b of the second wavelength division multiplexer 117, and then access the first photodetector 114 for demodulation. The generated signal is divided into two paths by the electrical splitter 118, in one of which the second signal filtered by the first electric band-pass filter 108 is amplified by the first electric amplifier 111. During the transmission, the fixed delay of the optical fiber and the external delay jitter caused by factors such as the environment will affect the stability of the transmission signal. Since the optical signal goes through the same optical path in the process of being input to the optical fiber, the fixed delay of the optical path is not considered. Assuming that the delay introduced when the optical signal is transmitted from the local end to the remote end for the first time is τ₁+τ₂+Δτ(t₁), then the expression of second signal is as follows:

V₂′(t)=cos{3ω[t−(τ₁+τ₂+Δτ(t₁))]} (1)

Where, τ₁ and τ₂ are the fixed delay of the optical fiber; Δτ(t₁) is the external delay jitter of the optical fiber link at time t₁, the signal then being sent to the input end a of the mixer 120.

In another path, the second electric bandpass filter 109 filters out the corresponding first signal and the first signal is amplified by the second electric amplifier 112 to be the radio frequency input of the second electro-optic modulator 208, and is performed with signal sideband modulation by the λ₂ optical carrier generated by the second laser 205. The optical carrier is input to the port a of the optical circulator 119, and then output from the port b of the optical circulator 119 to the port c of the second wavelength division multiplexer 117, and then transmitted back to the local end through the optical fiber 102 and the dispersion compensation module 101 at time t₂, and is connected to the Faraday rotating mirror 107 by the port c of the first wavelength division multiplexer 106. In this process, the delay introduced by the fixed delay of the optical fiber and the external delay jitter is τ₃+τ₄+τ₁+τ₅+Δτ(t₂).

The Faraday rotating mirror 107 reflects the signal, transmits the signal back to the remote end through the dispersion compensation module 101 and the optical fiber 102, and sends the signal to the port b of the optical circulator through the port c of the second wavelength division multiplexer 117 at the remote end, and then it is sent to the second photodetector 115 through the port c of the optical circulator for demodulation, and the corresponding first signal is filtered out by the third electric bandpass filter 110 and then amplified by the third electric amplifier 113. During this process, the delay introduced by the fixed delay of the optical fiber and the influence of external delay jitter is τ₁+τ₄+τ₅+τ₆+Δτ(t₃). Accordingly, the expression of the first signal reach the remote end after being transmitted three times is obtained as follows:

V₂′(t)=cos{ω[t−(3τ₁+τ₂+τ₃+τ₄+2τ₅+τ₆+Δτ(t₁)+Δτ(t₂)+Δτ(t₃))]} (2)

Where, τ₁:τ₆ is the fixed delay of the optical fiber; Δτ(t₁): Δτ(t₃) is the external delay jitter at different times. When the first signal is transmitted to the output port b of the mixer 120 and mixed with the second signal, the to-be-transmitted signal with frequency 2ω is as follows:

V(t)=cos{2ωt−2ω[τ₂−τ₄−τ₅+Δτ(t₁)]+ω[τ₃+τ₆+Δτ(t₂)+Δτ(t₃)]} (3)

Accordingly, the phase of the to-be-transmitted signal is:

Δφ(t)=ω[(2τ₄+2τ₅−2τ₂+τ₃+τ₆)+(Δτ(t₂)+Δτ(t₃)−2Δτ(t₁))] (4)

Through the reasonable design of the system, the fixed delay term 2τ₄+2τ₅−2τ₂+τ₃+τ₆, namely 2τ₄+2τ₅−2τ₂+τ₃+τ₆=0. So there is τ₂=τ₄+τ₅+½(τ₃+τ₆).

Since the system does not need an additional phase compensation device, it can realize a fast compensation response. The external jitter delay change speed caused by external environmental factors is very slow compared with the response speed of the system. Therefore, the external delay jitter at times t₁, t₂, and t₃ is approximately same, i.e., Δτ(t₁)=Δτ(t₂)=Δτ(t₃), therefore Δτ(t₂)+Δτ(t₃)−2Δτ(t₁)=0.

It can be seen that the present disclosure can realize the stable transmission of the to-be-transmitted signal by making the phase of the to-be-transmitted signal zero through reasonable design.

When a wideband signal is transmitted in the above system, there are frequency components that cannot be canceled by mixing. Assume that the maximum frequency offset component that cannot be eliminated is V₃(t)=cos[(ω+Δω)t], where, Δω is the frequency offset.

According to the above technical solution, after the frequency component is transmitted to the remote end three times, its expression becomes:

V₃(t)=cos{(ω+Δω)·[t−(3 τ₁+τ₂+τ₃+2τ₄+2τ₅+τ₆Δτ(t₁)+Δτ(t₂)+Δτ(t₃))]} (5)

This frequency component is mixed with the signal V₂′(t) at the remote end by mixer 120,

resulting in:

$${V}^{′} ( t ) = cos \{ \begin{matrix}( 2 ω - Δω ) t - 3 ω [ {τ}_{1} + {τ}_{2} + Δτ ( {t}_{1} ) ] + ( ω + Δω ) \cdot \\ [ 3 {τ}_{1} + {τ}_{2} + {τ}_{3} + 2 {τ}_{4} + 2 {τ}_{5} + {τ}_{6} + Δ τ ( {t}_{1} + Δτ ( {t}_{2} ) + Δ τ ( {t}_{3} ) ]\end{matrix} \} \qquad ( 6 )$$

Therefore, its phase is:

Δφ′(t)=ω[(2τ₄+2τ₅−2τ₂+τ₃+τ₆)+(Δτ(t₂)+Δτ(t₁))]+Δω·(τ₁+τ₂+τ₃+2τ₄+2τ₅+τ₆Δτ(t₁)+Δτ(₂)+Δτ(t₃)) (7)

In each shorter system response time, the above phase expression can be further simplified as:

Δφ₁(t)=Δω·(3τ₁+3τ₂+3Δτ(t₁) (8)

The residual phase jitter of the signal of the remote end after phase stabilization is expressed in the phase change in a period of time, and the fixed delay of the fiber has no effect on the phase change of the signal. Assuming that in the 0-t time period, the variation of external jitter is |Δτ(t)|, then the residual phase jitter of the far-end signal phase is |Δφ(t)|=|Δω|·3|Δτ(t)|.

In free transmission, its expression is:

V″(t)=cos [(2ω−Δω)(t−τ₁+τ₂+Δτ(t₁)))] (9)

Therefore, the residual phase jitter is:

|Δφ₂(t)|=(2ω−Δω)·|Δτ(t)| (10)

Therefore, after the phase stabilization system, the delay jitter compensation suppression ratio is:

$$a = \frac{\vert {Δφ}_{1} ( t ) \vert}{\vert {Δφ}_{2} ( t ) \vert} = \frac{3 \vert Δω \vert}{2 ω - Δ ω} \qquad ( 11 )$$

It can be seen that under the premise that the frequency of the to-be-transmitted first signal is 2ω, the greater the bandwidth of the first auxiliary signal, the worse the compensation and suppression ratio of the delay jitter of the system. When the compensation and suppression ratio is a, the maximum bandwidth of the transmissible signal of the system is

$$\vert Δω \vert = \frac{a}{3 + a} \cdot 2 ω .$$

The above description of the embodiments is for the convenience of those of ordinary skill in the art to understand and apply the present disclosure. It will be apparent to those skilled in the art that various modifications to the above examples can be readily made, and the general principles described herein can be applied to other embodiments without inventive effort. Therefore, the present disclosure is not limited to the above-mentioned embodiments, and improvements and modifications made by those skilled in the art according to the disclosure of the present disclosure should all fall within the protection scope of the present disclosure.

What is claimed is:

1. A broadband radio frequency signal optical fiber phase-stable transmission system, comprising a local end and a remote end connected by a dispersion compensation module and an optical fiber;
the local end is configured to modulate a first auxiliary signal whose frequency is half of the frequency of a to-be-transmitted signal, and a second auxiliary signal whose frequency is 1.5 times the frequency of the to-be-transmitted signal through the optical carrier, and filters out a lower sideband to obtain an optical signal containing only the optical carrier, a first signal, and a second signal corresponds to the optical signal of a first-order upper sideband; the optical signal is transmitted to the remote end through the dispersion compensation module and the optical fiber;
the remote end is configured to demodulate the first signal and second signal, and modulate the first signal by an optical carrier of another wavelength, and then transmit the modulated first signal to the local end and then returns to the remote end, allowing the first signal achieve three transmission in the system, and at last, to mix the first signal and the second signal to obtain a stable to-be-transmitted signal.

2. The system according to claim 1, wherein the local end comprises a first electro-optical modulation module, an optical filter, an optical isolator, a first wavelength division multiplexer, and a Faraday rotating mirror;
the first electro-optical modulation module is configured to modulate the first signal whose frequency is half of the frequency of the to-be-transmitted signal, and the second signal whose frequency is 1.5 times the frequency of the to-be-transmitted signal by the optical carrier to obtain a double-sideband signal containing the optical carrier, the first signal and the second signal corresponding to the first-order upper and lower sidebands; a lower sideband is filtered out by the optical filter, and then the double-sideband signal is transmitted from the optical fiber module to the remote end through the optical isolator and the first wavelength division multiplexer in turn;
the first wavelength division multiplexer is configured to couple two wavelength signals into the same optical fiber link;
the Faraday mirror is configured to reflect the first signal modulated by another wavelength and transmitted from the remote end to the local end back to the remote end again.

3. The system according to claim 1, wherein the remote end comprises first to third electrical filters, first to third electrical amplifiers, a first photodetectors, a second photodetectors, a second electro-optic modulation module, and a second wavelength division multiplexers, an electrical splitter, an optical circulator, and a mixer;
the first photodetector is configured to demodulate the optical signal from the local end to obtain the corresponding first signal and second signal, and the first signal is sent to an input end a of the mixer; the second signal is modulated by an optical carrier of another wavelength in the second electro-optic modulation module, and then transmitted to the local end by the optical fiber module through the second wavelength division multiplexer, and reflected back to the remote end by the Faraday rotating mirror at the local end, then demodulated by the second photodetector, sent to the input end b of the mixer, and mixed with the first signal;
the first to third electrical filters are band-pass filters, which are configured to filter the required signals;
the first to third electrical amplifiers are configured to amplify the signals filtered out by the electrical filters, thereby compensating for the signal transmission;
the second wavelength division multiplexer is configured to separate the optical signals of two different wavelengths coupled into the same optical fiber link;
the electrical splitter is configured to divide the signal demodulated by the first photodetector into two paths, one being the second signal filtered from the first electric filter and transmitted to the mixer, the other being the first signal filtered from the second electric filter and transmitted to the second electro-optic modulation module single-sideband modulation through the optical carrier of another wavelength;
the optical circulator is configured to change the transmission direction of the signal to realize back-forth transmission.

4. The system according to claim 1, wherein the dispersion compensation module is a section of dispersion compensation fiber, which is configured to compensate the delay effect on the signal due to different wavelengths of the optical carrier or drift and jitter of the carrier.

5. The system according to claim 2, wherein the first electro-optical modulator comprises a first signal source, a second signal source, a first laser, and a first electro-optic modulator;
the first signal source is configured to generate the first signal whose frequency is half the frequency of the to-be-transmitted signal; the first signal is a narrowband signal or a broadband signal with limited bandwidth;
the second signal source is configured to generate a frequency that is 1.5 times the frequency of the to-be-transmitted signal; the second signal is a local oscillator signal;
the first laser is configured to provide an optical signal with a wavelength of λ₁;
the first electro-optical modulator is a dual-parallel Mach-Zehnder modulator; an optical input port of the first electro-optical modulator is connected to the output port of the first laser; two radio frequency input ports of the first electro-optical modulator are connected to the output ports of the first signal source and the second signal source, respectively.

6. The system according to claim 3, wherein the second electro-optical modulation module includes a second laser, an electrical splitter, an electrical phase shifter, and a second electro-optical modulator;
the second laser is configured to provide an optical signal with a wavelength of λ₂;
the electrical splitter is configured to split the first signal modulated by the first electro-optical modulator into two paths, one of which being transmitted to the radio frequency input port of the second electro-optical modulator, the other to the electrical phase shifter;
the electrical phase shifter is configured to electrically shift the phase of the first signal modulated by the first electro-optical modulator;
the second electro-optical modulator is a dual-electrode Mach-Zehnder modulator; an optical input port of the second electro-optical modulator is connected to an optical output port of the second laser, and two RF input ports of the second electro-optical modulator are connected with the demodulated first signal and the phase-shifted first signal.
